(19) United States
(12) Patent Application Publication
(10) Pub. No.: US 2007/0044994 A1
(43) Pub. Date: Mar. 1, 2007

(54) Communication cable having spacer integrated with separator therein

(76) Inventors: Chan-Yong Park, Seoul (KR); Jong-Seb Baeck, Gyeongsangbuk-do (KR); Gi-Joon Nam, Seoul (KR); Woo-Yong Dong, Gyeongsangbuk-do (KR)

Correspondence Address: JONES DAY, 222 EAST 41ST ST, NEW YORK, NY, 10017, US

(21) Appl. No.: 11/511,755

(22) Filed: Aug. 28, 2006

(30) Foreign Application Priority Data
Aug. 30, 2005 (KR) KR10-2005-0080151

(51) Int. Cl. H01B 7/00

(52) U.S. Cl. 174/113 C

(57) ABSTRACT

A communication cable includes a separator prepared in the cable for preventing alien crosstalk, and at least one spacer integrally formed with the separator at a side of the separator contacting with an outside jacket. The spacer forms a protrusion protruded out on the cable, and this protrusion makes the transmission wires in the cable be spaced apart from adjacent cables. Thus, alien crosstalk generated due to proximity of other cables during high frequency signal transmission may be prevented.

### BACKGROUND OF THE INVENTION

1. Field of the Invention

The present invention relates to a communication cable, and more particularly to a communication cable capable of preventing alien crosstalk from an adjacent cable.

2. Description of the Related Art

Generally, a communication data cable is used for bulk data transmission using LAN (Local Area Network) or IBS (Intelligent Building System). The communication data cable is classified into Category 5, Category 6 and Category 7 depending on its transmission characteristic and also into UTP (Unshielded Twisted Pair) cable, FTP (Foiled Twisted Pair) cable and STP (Shielded Twisted Pair) cable depending on its shield type.

An UTP cable generally transmits signals at a rate of about 100 Mbps. In order to enhance the transmission rate of signals through the UTP cable over 1 Gbps, a frequency of about 500 MHz should be used. However, in case a higher frequency is used for high-speed transmission of signals, there occur internal crosstalk between pair units in the UTP cable, attenuation of signal passing along copper, and delay of signals. In order to prevent the internal crosstalk between pair units in the UTP cable, a cable having a shield film between the pair units has been proposed (for example, see Korean Patent No. 0330921).

Conventional communication data cables mostly transmit data under low frequency environments. Thus, internal crosstalk does not arise, or it may be compensated using DSP (Digital Signal Process) in consideration of factors causing crosstalk.

However, differently from a conventional system using about 80 MHz frequency for transmission of gigabit signals, an improved system designed for signal transmission over gigabit should process the signals in the frequency range of 400˜625 MHz in order to increase the number of signals per unit time. At this time, the internal noise of a cable additionally caused by frequency expansion may be compensated using the degree of twist of the cable pair units. In addition, the internal noise of the cable may be fundamentally compensated using DSP. However, alien crosstalk generated due to the influence of adjacent cables is variously changed depending on external environments of the cable, so it may not be easily compensated using DSP.

In order to solve the above alien crosstalk problem, STP cable or FTP cable in which a shielding member made of a metal film is inserted into a cable jacket is used. However, the STP cable and the FTP cable have an increased weight and a deteriorated flexibility due to the use of a shielding member. In addition, in order to produce STP cable or FTP cable, a process step for inserting a shielding member into a cable should be added, so the cable producing process becomes complicated and difficult.

In addition, in case a shielding member made of metal film is inserted, attenuation or delay of signals becomes worse since material with a high dielectric constant is applied around a copper.

### SUMMARY OF THE INVENTION

The present invention is designed to solve the problems of the prior art, and therefore it is an object of the present invention to provide a communication cable capable of preventing alien crosstalk from adjacent cables.

In order to accomplish the above object, the present invention provides a communication cable, which includes at least two pair units in each of which at least two insulation-coated wires are spirally twisted in a sheath; a separator having a barrier for separating the pair units from each other; at least one spacer integrally formed with the separator and protruded from a barrier end of the separator; and an outside jacket surrounding the separator and the pair units separated by the separator and having a protrusion protruded along the spacer.

Preferably, the spacer has a sectional diameter or height of 1.0 to 3.0 mm.

More preferably, the protrusion of the outside jacket formed by the spacer has a pitch in the range of 30 to 120 mm.

### BRIEF DESCRIPTION OF THE DRAWINGS

Other objects and aspects of the present invention will become apparent from the following description of embodiments with reference to the accompanying drawing in which:

FIG. 1 is a sectional view showing a UTP (Unshielded Twisted Pair) cable according to the prior art;

FIG. 2 is a sectional view showing a communication cable according to a preferred embodiment of the present invention;

FIGS. 3 to 6 are sectional views showing a separator and a spacer longitudinally inserted into the communication cable according to modifications of the present invention;

FIG. 7 is a photograph showing a communication cable produced according to a preferred embodiment of the present invention;

FIG. 8 is a graph showing alien crosstalk of an UTP cable produced according to a comparative example; and

FIG. 9 is a graph showing alien crosstalk of the communication cable produced according to an embodiment of the present invention.

### DESCRIPTION OF THE PREFERRED EMBODIMENT

Hereinafter, preferred embodiments of the present invention will be described in detail referring to the accompanying drawings. Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

FIG. 2 is a sectional view showing a communication cable according to a preferred embodiment of the present invention. Referring to FIG. 2, the communication cable according to this embodiment includes four pair units 20 in each of which two insulation-coated wires are spirally twisted, a separator 30 for isolating and separating the pair units 20 from each other, an outside jacket 50 surrounding the pair units 20 and the separator 30, an a spacer 40 integrally formed with a barrier end of the separator 30 to protrude a part of the outside jacket 50 to outside.

The pair unit 20 is formed by twisting at least two wires 21. At this time, if many pair units 20 have pitches identical or similar to each other, internal crosstalk may be easily generated between the pair units included in a cable. Thus, the pair units 20 are preferably adjusted to have different pitches from each other.

In addition, in case the pair unit 20 has a pitch less than 7.0 mm, the wires become longer to abruptly increase data loss. In addition, in case the pair unit 20 has a pitch greater than 30 mm, the cable is structurally unstable and may not keep its shape. Thus, the pair unit 20 preferably has a pitch of 7.0 to 30 mm. More preferably, the pitch of the pair unit 20 may be set in the range of 8.0 to 13 mm.

Furthermore, the number of pair units 20 provided in a cable may be variously changed, not limited to this embodiment.

The separator 30 has barriers crossing with each other so as to isolate the pair units 20 from each other. In addition, the separator 30 may be twisted with a predetermined pitch in a length direction.

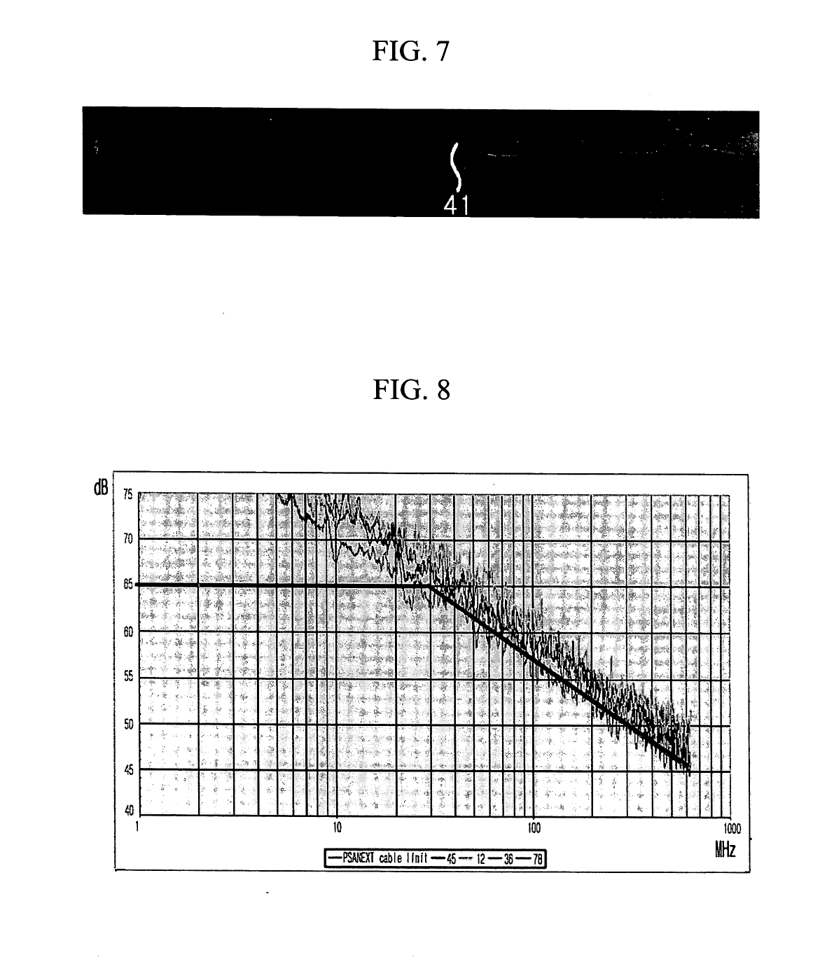

The spacer 40 may be provided to a barrier end of the separator 30, namely to a face of the barrier contacting with the outside jacket. Since the spacer 40 is provided, a protrusion 41 is continuously formed on an outside of the outside jacket 50. Since the separator 30 is spirally twisted, the protrusion 41 is formed in a spiral shape with keeping a predetermined pitch (see FIG. 7). Thus, the cable may keep a predetermined spacing distance from an adjacent cable.

Here, if a diameter or height of the spacer 40, or a distance between a point of the spacer 40 contacting with the outside jacket and an end of the separator 30, is less than 1.0 mm, a spacing distance is not so sufficient to prevent alien crosstalk between cables. In addition, if the spacer 40 has a diameter or height greater than 3.0 mm, the spacing distance is sufficient, but much material is unnecessarily consumed to increase weight of the cable. Thus, the height or diameter of the spacer 40 is preferably in the range of 1.0 to 3.0 mm.

In case the separator 30 and the spacer 40 are separately inserted into the cable, the pair units 20 may be pressed. Thus, the separator 30 and the spacer 40 are preferably provided integrally so that the pair units 20 are not pressed during the producing process to ensure stable transmission characteristics. In addition, in case the separator 30 and the spacer 40 are integrally manufactured, the separator 30 and the spacer 40 may be formed together by extrusion, so it is possible to simplify the producing process and manufacture costs.

Meanwhile, in the point that the protrusion 41 formed on the spacer 40 has a predetermined pitch, it is preferred that the pair units 20 are put into each space formed by the barriers of the separator 30 one by one and then twisted before the outside jacket 50 is coated.

Though it has been described that the pair units 20, the separator 30 and the spacer 40 are twisted before the outside jacket 50 is coated, the present invention is not limited thereto. For example, it is possible that the outside jacket 50 is coated in the state that each pair unit 20 is put into each space formed by the barriers of the separator 30, and then the entire cable is twisted with a predetermined pitch.

Meanwhile, if the protrusion 41 formed by the separator 30 and the spacer 40, spirally twisted, has a pitch greater than 120 mm, an interval between pitches is increased so that adjacent cables may come in contact and thus easily generate alien crosstalk. In addition, if the protrusion 41 has a pitch less than 30 mm, a spacing distance is stably kept but much material is consumed and the cable has an increased weight. Thus, a pitch of the protrusion 41 is preferably kept in the range of 30 to 120 mm. More preferably, a pitch of the protrusion 41 may be set in the range of 50 to 80 mm.

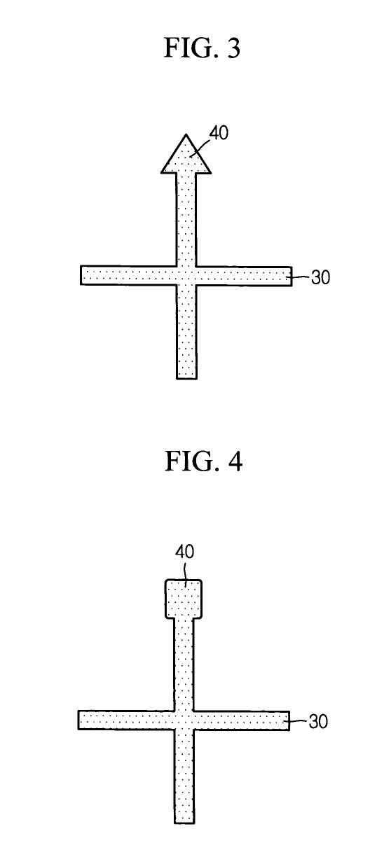

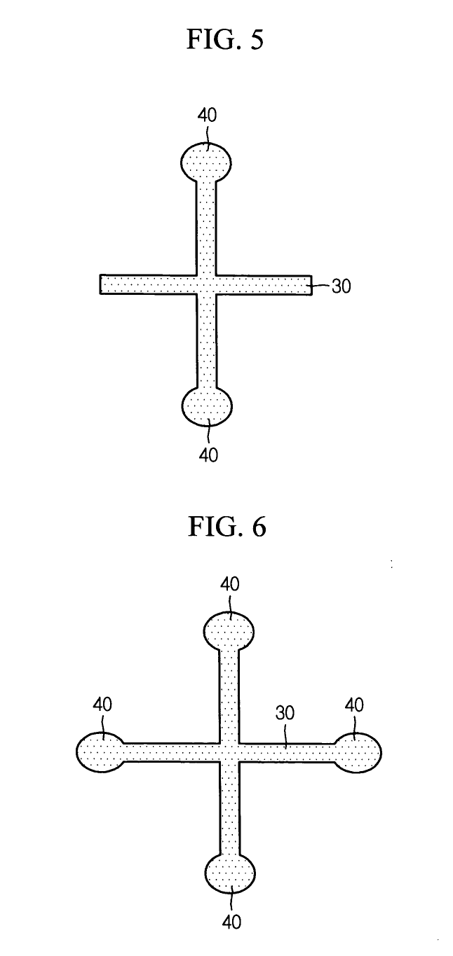

Shape and number of the spacer 40 may be variously changed as shown in FIGS. 3 to 6.

In addition, though it has been described that the separator 30 has four barriers in the above embodiment, the number of barriers may be variously changed. That is to say, the separator 30 may have any sectional configuration if it may isolate a plurality of pair units 20 from each other.

Now, the communication cable of the present invention capable of preventing alien crosstalk in a high-speed data transmission environment will be described in more detail based on the following examples.

### COMPARATIVE EXAMPLE

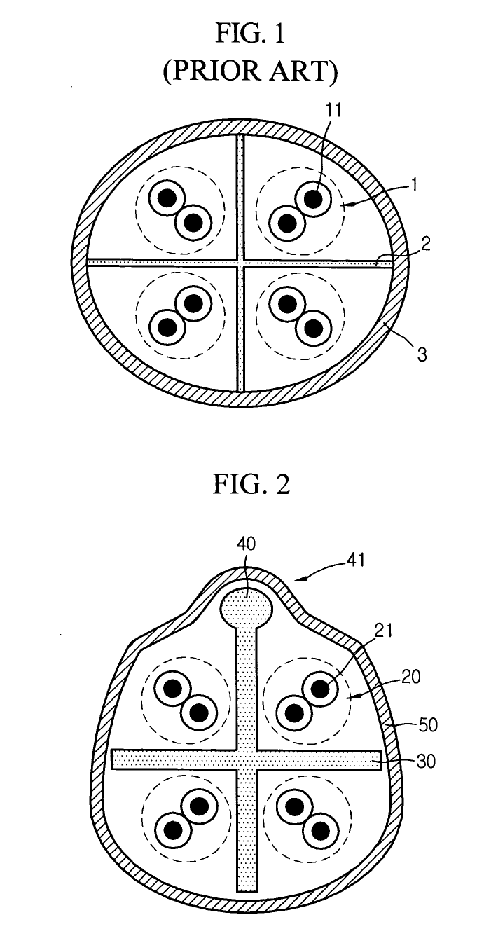

A conventional Cat.6 cable is selected for this comparative example (see FIG. 1). The cable used in this comparative example includes four pair units 1 in each of which two wires 11 are spirally twisted, a separator 2 for isolating the pair units 1 from each other, and an outside jacket 3 surrounding the pair units 1 and the separator 2. A twisting pitch of four pair units 2 is set to 18 mm or less. The outside jacket 3 is made of PVC (polyvinyl chloride) with a thickness of 0.6 mm. In addition, there is no structure installed on the cable used in this comparative example.

By using the conventional cable mentioned above, signals are transmitted over a length of 100 m with changing frequencies in the range of 1 MHz to 500 MHz according to the IEEE 802.3 draft standard. At this time, data loss caused by alien crosstalk was measured, and the measurement results are shown in FIG. 8. A solid line in FIG. 8 shows an alien crosstalk criterion proposed in the IEEE 802.3 draft standard, and a waved line is a measurement result of this comparative example.

### EXPERIMENTAL EXAMPLE

The cable used in this experimental example includes four pair units 20 in each of which two wires 21 are spirally twisted, a separator 30 for isolating the pair units 20 from each other, an outside jacket 50 surrounding the pair units 20 and the separator 30, and a spacer 40 integrally formed with the barrier end of the separator 30 to protrude a part of the outside jacket 50 outward (see FIG. 2). Four pair units 20 have pitches adjusted to be different from each other in the range of 8.0 to 13 mm. In addition, one circular spacer 40 is integrally formed at one end of the separator 30. At this time, the spacer 40 has a diameter of 2 mm. The separator 30 and the spacer 40, integrally formed, is made of HDPE (High Density Polyethylene). In addition, the outside jacket 50 is made of PVC with a thickness of 0.8 mm.

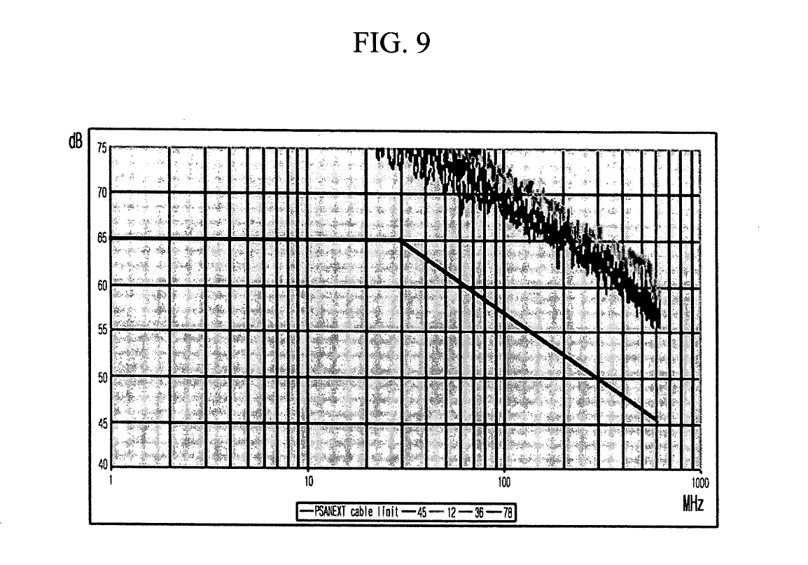

By using the above cable mentioned above prepared by this experimental example according to the present invention, signals are transmitted over a length of 100 m with changing frequencies in the range of 1 MHz to 500 MHz according to the IEEE 802.3 draft standard. At this time, data loss caused by alien crosstalk was measured, and the measurement results are shown in FIG. 9. A solid line in FIG. 9 shows an alien crosstalk criterion proposed in the IEEE 802.3 draft standard, and a waved line is a measurement result of this experimental example of the present invention.

Referring to FIG. 8, the cable produced by the comparative example according to the prior art passed all tests including fitted impedance, return loss, attenuation, NEXT (Near End Crosstalk), FEXT (Far End Crosstalk), and ELFEXT (Equal Level Far End CrossTalk). However, in the experiment of measuring alien crosstalk between cables, a worst margin was in the level of −9.0 dB, which is much less than a standard criterion.

Meanwhile, referring to FIG. 9, the cable produced according to the present invention passed all tests including fitted impedance, return loss, attenuation, NEXT, FEXT, and ELFEXT. In addition, in the experiment of measuring alien crosstalk between cables, this cable shows a worst margin in the level of 7.0 dB, which is much higher than a standard criterion.

As described above, the present invention has been described in detail referring to the accompanying drawings. However, it should be understood that the detailed description and specific embodiments of the invention are given by way of illustration only, not intended to limit the scope of the invention, since various changes and modifications within the spirit and scope of the invention will become apparent to those skilled in the art from this detailed description, so it should be understood that other equivalents and modifications within the spirit and scope of the invention will become apparent to those skilled in the art from this detailed description.

### APPLICABILITY TO THE INDUSTRY

According to the communication cable of the present invention, it is possible to prevent alien crosstalk generated between cables during transmission of high-frequency signals.

In addition, since the separator and the spacer are integrally formed, it is possible to restrain pressure applied to the pair units.

What is claimed is:

1. A communication cable, comprising:
at least two pair units in each of which at least two insulation-coated wires are spirally twisted in a sheath;
a separator having a barrier for separating the pair units from each other;
at least one spacer integrally formed with the separator and protruded from a barrier end of the separator; and
an outside jacket surrounding the separator and the pair units separated by the separator and having a protrusion protruded along the spacer.

2. The communication cable according to claim 1,
wherein the spacer has a sectional diameter or height of 1.0 to 3.0 mm.

3. The communication cable according to claim 1,
wherein the protrusion of the outside jacket formed by the spacer has a pitch in the range of 30 to 120 mm.

4. The communication cable according to claim 1,
wherein the separator is shaped in a radial direction.

5. The communication cable according to claim 1,
wherein the protrusion has a spiral shape in a length direction.

6. The communication cable according to claim 1,
wherein the wires included in the at least two pair units are twisted with different pitches from each other.

7. The communication cable according to claim 6,
wherein the wires are twisted with a pitch in the range of 7.0 to 30 mm.
